(19) United States
(12) Patent Application Publication
(10) Pub. No.: US 2025/0280885 A1
(43) Pub. Date: Sep. 11, 2025

(54) ELECTRODE AND ELECTRONIC ATOMIZATION DEVICE

(71) Applicant: SHENZHEN SMOORE TECHNOLOGY LIMITED, Shenzhen (CN)

(72) Inventors: Huanxi LI, Shenzhen (CN); Yubin XIAN, Shenzhen (CN); Hongming ZHOU, Shenzhen (CN)

(21) Appl. No.: 19/219,435

(22) Filed: May 27, 2025

Related U.S. Application Data
(63) Continuation of application No. PCT/CN2023/116989, filed on Sep. 5, 2023.

(30) Foreign Application Priority Data
Nov. 28, 2022 (CN) 202223171320.2

(51) Int. Cl. A24F 40/465

(52) U.S. Cl. CPC A24F 40/465

(57) ABSTRACT

An electrode disposed in an electronic atomization device includes: a first electrical conduction member; and a second electrical conduction member, the second electrical conduction member being disposed, for discharging, at an end of the first electrical conduction member along an extending direction. A heat resistance of the second electrical conduction member is greater than a heat resistance of the first electrical conduction member.

### CROSS-REFERENCE TO PRIOR APPLICATION

This application is a continuation of International Patent Application No. PCT/CN2023/116989, filed on Sep. 5, 2023, which claims priority to Chinese Patent Application No. 202223171320.2, filed on Nov. 28, 2022. The entire disclosure of both applications is hereby incorporated by reference herein.

### FIELD

This application relates to the field of atomization technologies, and in particular, to an electrode and an electronic atomization device.

### BACKGROUND

An aerosol is a colloid dispersion system formed by solid or liquid small particles dispersed and suspended in a gas medium. Since the aerosol can be absorbed by a human body through a respiratory system, a new alternative absorption manner is provided for users. For example, an atomization device that can produce the aerosol by baking and heating an aerosol-generating material of a herbal type or an ointment type is provided, and the atomization device can be used in different fields to deliver an inhalable aerosol to the users, replacing a conventional product form and a conventional absorption manner.

Generally, the aerosol-generating material is atomized into aerosol by using an atomizer in an electronic atomization device. Plasma heating atomization is a type of atomization manner, which specifically uses an arc generated by high-voltage air discharge by using an electrode, to heat the aerosol-generating material. In addition, a temperature of the arc generated by the high-voltage air discharge is as high as about 2000 degrees centigrade. For adaptability and processability of an electrode structure, a metal conductor electrode is usually selected for the electrode, but a common metal electrode is easily ablated or oxidized due to a high temperature, and has a short service life.

### SUMMARY

In an embodiment, the present invention provides an electrode disposed in an electronic atomization device, the electrode comprising: a first electrical conduction member; and a second electrical conduction member, the second electrical conduction member being disposed, for discharging, at an end of the first electrical conduction member along an extending direction, wherein a heat resistance of the second electrical conduction member is greater than a heat resistance of the first electrical conduction member.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic atomization device according to an embodiment of this application;

FIG. 2 is a schematic cross-sectional diagram of the electronic atomization device shown in FIG. 1;

FIG. 3 is a schematic structural diagram of the electronic atomization device shown in FIG. 1 without an inner pot mounted;

FIG. 4 is a schematic structural diagram of an electronic atomization device without an inner pot mounted according to another embodiment of this application; and

FIG. 5 is a schematic cross-sectional diagram of the electronic atomization device shown in FIG. 4.

### DETAILED DESCRIPTION

In an embodiment, the present invention provides an electrode and an electronic atomization device to solve the problem of a short service life of an electrode used for plasma heating atomization.

In an embodiment, the present invention provides an electrode. The electrode is disposed in an electronic atomization device and includes a first electrical conduction member and a second electrical conduction member, and the second electrical conduction member is disposed at the end along the extending direction of the first electrical conduction member for discharging, where

the heat resistance of the second electrical conduction member is greater than the heat resistance of the first electrical conduction member.

The foregoing electrode includes the first electrical conduction member and the second electrical conduction member, the second electrical conduction member is disposed at the end along the extending direction of the first electrical conduction member for discharging, and the heat resistance of the second electrical conduction member is greater than the heat resistance of the first electrical conduction member. In other words, the electrode is divided into two parts, and the second electrical conduction member located at an end portion for discharging has the strong heat resistance, and is not easily ablated or oxidized by a high-temperature arc. In this way, the heat resistance and the ablative resistance of the part of the electrode are increased, to increase the service life of the electrode.

In an embodiment, an end portion along the extending direction of the first electrical conduction member is enclosed to form a mounting space, and part of the second electrical conduction member is sleeved in the mounting space.

In an embodiment, the second electrical conduction member includes a mounting portion and a discharge portion that are intersected and connected, the mounting portion is sleeved in the mounting space, and the discharge portion is disposed protruding out of the first electrical conduction member along the direction intersecting with the extending direction of the first electrical conduction member.

In an embodiment, the material of the first electrical conduction member is a metal, and the material of the second electrical conduction member is a semiconductor ceramic or a metal alloy.

In an embodiment, the material of the second electrical conduction member is the metal alloy, and the metal alloy is one of a copper alloy, an iron-based alloy, a nickel-based alloy, a cobalt-based alloy, and a powder metallurgy alloy.

In an embodiment, the second electrical conduction member is fixedly connected to the end along the extending direction of the first electrical conduction member.

In an embodiment, the second electrical conduction member is constructed as a semiconductor ceramic layer which is sintered and covers the end along the extending direction of the first electrical conduction member.

In an embodiment, the first electrical conduction member includes a first conduction portion and a second conduction portion that are connected to each other, the second conduction portion is disposed protruding out of the first conduction portion along the direction intersecting with the extending direction of the first conduction portion, and the semiconductor ceramic layer covers the outer periphery of the second conduction portion.

An electronic atomization device is provided. The electronic atomization device includes a housing assembly and at least two electrodes as described herein, the interior of the housing assembly forms a heating cavity and an accommodating cavity that are adjacent to each other, the at least two electrodes extend into the heating cavity and are controlled to discharge for generating an arc, and the accommodating cavity is configured to accommodate an aerosol-generating material.

In an embodiment, the housing assembly includes a shell and an inner pot, the inner pot is detachably disposed on the shell, the heating cavity is defined between the inner pot and the shell, the inner pot includes the accommodating cavity, and the electrode is disposed on the shell and partially extends into the heating cavity.

### LIST OF REFERENCE NUMERALS

100: Electronic atomization device; 10: Housing assembly; 12: Shell; 14: Inner pot; 141: Accommodating cavity; 20: Heating cavity; 30: Electrode; 32: First electrical conduction member; 321: First conduction portion; 323: Second conduction portion; 33: Mounting space; 34: Second electrical conduction member; 341: Mounting portion; and 343: Discharge portion.

To make the foregoing objects, features, and advantages of this application clearer and easier to understand, the following describes specific implementations of this application in detail with reference to the accompanying drawings. In the following descriptions, many specific details are described to fully understand this application. However, this application can be implemented in many other manners different from those described herein. A person skilled in the art can make similar improvements without departing from the connotation of this application. Therefore, this application is not limited to the specific embodiments disclosed below.

In the descriptions of this application, it is to be understood that orientation or position relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, and “circumferential” are based on orientation or position relationships shown in the accompanying drawings, and are used only for ease of describing this application and simplifying the descriptions, rather than indicating or implying that the mentioned device or component have to have a particular orientation or have to be constructed and operated in a particular orientation. Therefore, such terms cannot be construed as a limitation to this application.

In addition, terms “first” and “second” are merely for description, and cannot be understood as indicating or implying relative importance or implying a quantity of technical features indicated. Therefore, features defined by “first” and “second” may explicitly indicate or implicitly include at least one of such features. In the descriptions of this application, “a plurality of” means at least two, such as two or three, unless otherwise explicitly and specifically defined.

In this application, unless otherwise explicitly specified or defined, terms such as “mount”, “connected”, “connection”, and “fix” should be understood in a broad sense. For example, the connection may be a fixed connection, a detachable connection, or an integral connection; or the connection may be a mechanical connection, or an electrical connection; or the connection may be a direct connection, an indirect connection through an intermediary, or internal communication between two elements or a mutual action relationship between two elements, unless otherwise specified explicitly. A person of ordinary skill in the art may understand specific meanings of the foregoing terms in this application based on specific situations.

In this application, unless otherwise explicitly specified and defined, that a first feature is “above” or “below” a second feature may be that the first feature directly contacts with the second feature, or the first feature indirectly contacts with the second feature through an intermediary. In addition, that the first feature is “above”, “over”, or “on” the second feature may be that the first feature is directly above or obliquely above the second feature, or may merely indicate that the first feature is at a higher horizontal position than the second feature. That the first feature is “under”, “below”, and “on the bottom of” the second feature may be that the first feature is directly below or obliquely below the second feature, or may merely indicate that the first feature is at a lower horizontal position than the second feature.

It should be noted that when an element is referred to as being “fixed to” or “disposed on” another element, the element may be directly on the another element, or there may be an intervening element. When an element is considered to be “connected to” another element, the element may be directly connected to the another element, or there may be an intervening element. The terms “vertical”, “horizontal”, “upper”, “lower”, “left”, “right”, and similar expressions used herein are merely intended for description, and do not indicate a unique implementation.

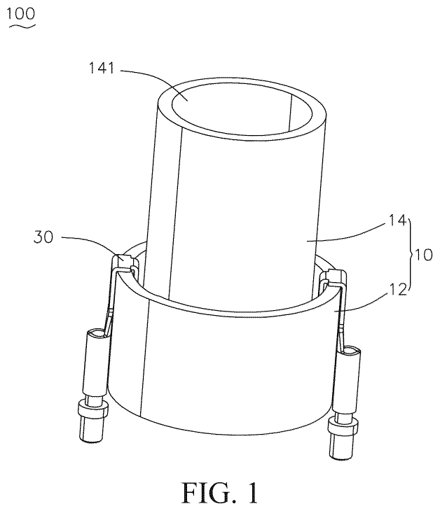

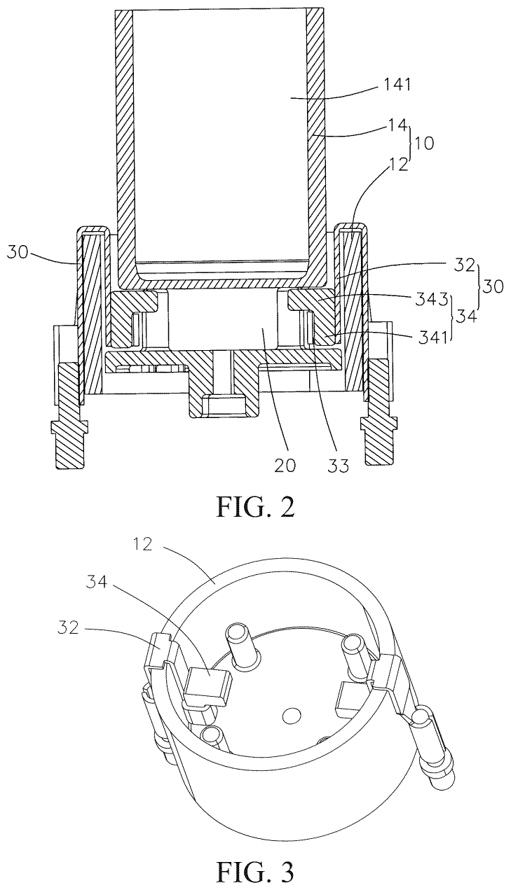

Referring to FIG. 1 to FIG. 3, in an embodiment of this application, an electronic atomization device 100 is provided. The electronic atomization device 100 includes a housing assembly 10 and at least two electrodes 30, the interior of the housing assembly 10 forms a heating cavity 20 and an accommodating cavity 141 that are adjacent to each other, the at least two electrodes 30 extend into the heating cavity 20 and are controlled to discharge for generating an arc, and the accommodating cavity 141 is configured to accommodate an aerosol-generating material. When the electronic atomization device 100 is in operation, the aerosol-generating material is put into the accommodating cavity 141, and the electrode 30 is controlled to discharge for generating the arc in the heating cavity 20. In this way, plasma is generated in the heating cavity 20, so that high energy of the plasma is used to heat the aerosol-generating material in the accommodating cavity 141.

In some embodiments, the electrode 30 includes a first electrical conduction member 32 and a second electrical conduction member 34, the second electrical conduction member 34 is disposed at the end along the extending direction of the first electrical conduction member 32 for discharging, and the heat resistance of the second electrical conduction member 34 is greater than the heat resistance of the first electrical conduction member 32. In other words, the electrode 30 is divided into two parts, and the second electrical conduction member 34 located at the end portion for discharging has the strong heat resistance, and is not easily ablated or oxidized by a high-temperature arc. In this way, the heat resistance and the ablative resistance of the part of the electrode 30 are increased, to increase a service life of the electrode 30. It may be understood that, the first electrical conduction member 32 is constructed in a long strip shape for being electrically connected to a power supply circuit. The extending direction of the first electrical conduction member 32 is the longitudinal direction of the first electrical conduction member 32.

In some embodiments, the end portion along the extending direction of the first electrical conduction member 32 is enclosed to form a mounting space 33, and part of the second electrical conduction member 34 is sleeved in the mounting space 33. In this way, the first electrical conduction member 32 and the second electrical conduction member 34 are connected by mutually sleeving. In addition, the first electrical conduction member 32 and the second electrical conduction member 34 are ensured to be in contact for an electrical connection.

Further, the second electrical conduction member 34 includes a mounting portion 341 and a discharge portion 343 that are intersected and connected, the mounting portion 341 is sleeved in the mounting space 33, and the discharge portion 343 is disposed protruding out of the first electrical conduction member 32 along the direction intersecting with the extending direction of the first electrical conduction member 32. In other words, the discharge portion 343 protrudes from the first electrical conduction member 32 along the direction intersecting with the extending direction of the first electrical conduction member 32. The discharge portion 343 may be used as the farthest end of the electrode 30, to cause the arc to be generated between two discharge portions 343 with the shortest distance between two adjacent electrodes 30, to effectively use the second electrical conduction member 34 with the better heat resistance to discharge for generating the arc, thereby ensuring the service life.

Specifically, in this embodiment, the material of the first electrical conduction member 32 is a metal, and the material of the second electrical conduction member 34 is a semiconductor ceramic or a metal alloy. The material of the first electrical conduction member 32 is the metal, which can effectively conduct electricity and is conveniently connected to the power supply circuit. The material of the second electrical conduction member 34 is the semiconductor ceramic or the metal alloy, which has the good heat resistance, and can be electrically connected to the first electrical conduction member 32, to discharge for generating the arc.

Optionally, the material of the second electrical conduction member 34 is the metal alloy, and the metal alloy is one of a copper alloy, an iron-based alloy, a nickel-based alloy, a cobalt-based alloy, and a powder metallurgy alloy, which has the good heat resistance.

Further, optionally, the material of the second electrical conduction member 34 is the semiconductor ceramic. The semiconductor ceramic is germanium and silicon and compounds thereof, gallium arsenide and gallium phosphide compounds, cadmium sulfide and zinc sulfide compounds, and oxides such as manganese, chromium, iron, copper oxides, gallium aluminum arsenic, or gallium arsenic phosphide compounds, which can conduct electricity and have the good heat resistance.

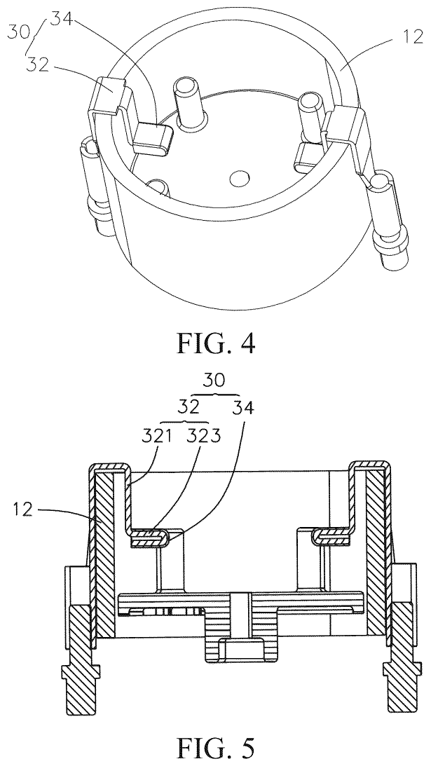

Referring to FIG. 4 and FIG. 5, in some other embodiments, the second electrical conduction member 34 is fixedly connected to the end along the extending direction of the first electrical conduction member 32. In this way, the first electrical conduction member 32 and the second electrical conduction member 34 are fixedly connected, and a connection is more reliable. In addition, the second electrical conduction member 34 is located at the end portion along the extending direction of the first electrical conduction member 32, and can be used as a tip end of the electrode 30 to discharge for generating the arc.

Further, the second electrical conduction member 34 is constructed as a semiconductor ceramic layer, and the semiconductor ceramic layer is sintered and covers the end along the extending direction of the first electrical conduction member 32. The second electrical conduction member 34 is constructed as the semiconductor ceramic layer. In this way, the second electrical conduction member 34 can be conveniently sintered and connected to the first electrical conduction member 32. In addition, the second electrical conduction member 34 can conduct electricity and has the good heat resistance, so that the second electrical conduction member 34 can withstand a high-temperature arc spot, and the service life of the electrode 30 can be prolonged.

Specifically, the first electrical conduction member 32 includes a first conduction portion 321 and a second conduction portion 323 that are connected to each other, the second conduction portion 323 is disposed protruding out of the first conduction portion 321 along the direction intersecting with the extending direction of the first conduction portion 321, and the semiconductor ceramic layer covers the outer periphery of the second conduction portion 323, to sinter the semiconductor ceramic layer on the second conduction portion 323. In addition, the second conduction portion 323 is disposed protruding along the direction intersecting with the extending direction of the first conduction portion 321. Along the direction intersecting with the extending direction of the first conduction portion 321, the second conduction portion 323 is the farthest end of the electrode 30, and the semiconductor ceramic layer covering the second conduction portion 323 is also the farthest end. The distance between two semiconductor ceramic layers between two adjacent electrodes 30 is the shortest, so that discharging can be performed for generating the arc. The semiconductor ceramic layer with the good heat resistance withstands the high-temperature arc spot, thereby preventing the electrode 30 from being ablated and increasing the service life of the electrode 30.

In some embodiments, the housing assembly 10 includes a shell 12 and an inner pot 14, the inner pot 14 is detachably disposed on the shell 12, the heating cavity 20 is defined between the inner pot 14 and the shell 12, the inner pot 14 includes the accommodating cavity 141, and the electrode 30 is disposed on the shell 12 and partially extends into the heating cavity 20. In this way, the electrode 30 is fixedly mounted by using the shell 12, and the accommodating cavity 141 of the inner pot 14 is configured to place the aerosol-generating material. When the aerosol-generating material needs to be heated and atomized, the electrode 30 is controlled to discharge in the heating cavity 20 to generate the arc, thereby forming the plasma to heat the inner pot 14 and the aerosol-generating material in the inner pot 14. In addition, the inner pot 14 is detachably disposed, so that after being used for a period of time, the inner pot 14 is conveniently detached and cleaned, thereby ensuring an atomization taste.

In an embodiment of this application, the electrode 30 according to any one of the foregoing embodiments is further provided. The electrode 30 includes a first electrical conduction member 32 and a second electrical conduction member 34, the second electrical conduction member 34 is disposed at the end along the extending direction of the first electrical conduction member 32 for discharging, and the heat resistance of the second electrical conduction member 34 is greater than the heat resistance of the first electrical conduction member 32. In other words, the electrode 30 is divided into two parts, and the second electrical conduction member 34 located at the end portion for discharging has the strong heat resistance, and is not easily ablated or oxidized by a high-temperature arc. In this way, the heat resistance and the ablative resistance of the part of the electrode 30 are increased, to increase the service life of the electrode 30. It may be understood that, the first electrical conduction member 32 is constructed in a long strip shape for being electrically connected to a power supply circuit. The extending direction of the first electrical conduction member 32 is the longitudinal direction of the first electrical conduction member 32.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An electrode disposed in an electronic atomization device, the electrode comprising:
a first electrical conduction member; and
a second electrical conduction member, the second electrical conduction member being disposed, for discharging, at an end of the first electrical conduction member along an extending direction,
wherein a heat resistance of the second electrical conduction member is greater than a heat resistance of the first electrical conduction member.

2. The electrode of claim 1, wherein an end portion along the extending direction of the first electrical conduction member is enclosed so as to form a mounting space, and
wherein part of the second electrical conduction member is sleeved in the mounting space.

3. The electrode of claim 2, wherein the second electrical conduction member comprises a mounting portion and a discharge portion that are intersected and connected,
wherein the mounting portion is sleeved in the mounting space, and
wherein the discharge portion is disposed protruding out of the first electrical conduction member along a direction intersecting with the extending direction of the first electrical conduction member.

4. The electrode of claim 1, wherein a material of the first electrical conduction member comprises a metal, and
wherein a material of the second electrical conduction member comprises a semiconductor ceramic or a metal alloy.

5. The electrode of claim 4, wherein the material of the second electrical conduction member comprises the metal alloy, and
wherein the metal alloy comprises one of a copper alloy, an iron-based alloy, a nickel-based alloy, a cobalt-based alloy, and a powder metallurgy alloy.

6. The electrode of claim 1, wherein the second electrical conduction member is fixedly connected to the end along the extending direction of the first electrical conduction member.

7. The electrode of claim 6, wherein the second electrical conduction member comprises a semiconductor ceramic layer, and
wherein the semiconductor ceramic layer is sintered and covers the end along the extending direction of the first electrical conduction member.

8. The electrode of claim 6, wherein the first electrical conduction member comprises a first conduction portion and a second conduction portion that are connected to each other,
wherein the second conduction portion is disposed protruding out of the first conduction portion along a direction intersecting with the extending direction of the first conduction portion, and
wherein the semiconductor ceramic layer covers an outer periphery of the second conduction portion.

9. An electronic atomization device, comprising:
a housing assembly; and
at least two of the electrode of claim 1,
wherein an interior of the housing assembly forms a heating cavity and an accommodating cavity that are adjacent to each other,
wherein the at least two electrodes extend into the heating cavity and are controlled to discharge so as to generate an arc, and
wherein the accommodating cavity is configured to accommodate an aerosol-generating material.

10. The electronic atomization device of claim 9, wherein the housing assembly comprises a shell and an inner pot,
wherein the inner pot is detachably disposed on the shell,
wherein the heating cavity is defined between the inner pot and the shell,
wherein the inner pot comprises the accommodating cavity, and
wherein the at least two electrodes are disposed on the shell and partially extend into the heating cavity.
